(19) United States
(12) Patent Application Publication
(10) Pub. No.: US 2004/0069633 A1
(43) Pub. Date: Apr. 15, 2004

(54) Electrophoretic devices with nanometer-scale, metallic elements

(75) Inventors: Michael P. Surh, Livermore, CA (US); William D. Wilson, Pleasanton, CA (US); Troy W. Barbee JR., Palo Alto, CA (US); Stephen M. Lane, Oakland, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 10/262,015

(22) Filed: Sep. 30, 2002

(51) Int. Cl. G01L 1/20

(52) U.S. Cl. 204/451

(57) ABSTRACT

Nanolaminate materials are composites that consist of alternating layers of different materials (often conducting and insulating materials) that are manufactured by repeated sputter coating of a flat substrate. The layers can be exceedingly thin—on the order of a few atomic layers up to hundreds of nanometers. When the composite is cut perpendicular to the planes of these layers, a surface results that along one dimension has closely spaced alternating stripes of the materials. This patterned surface is incorporated into electrochemical and electrophoretic devices. The device may be positioned such that sample fluid may pass horizontally or vertically relative to the exposed closely spaced stripes. Such a device may be constructed to use an array of discrete conducting layers to define a voltage gradient so as to perform electrophoretic transport in a narrow fluid channel with one surface defined by the nanolaminate material.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to electrophoretic devices, particularly to electrophoretic devices using metal/insulator nano-laminates, and more particularly to electrophoretic devices with nanometer-scale metallic elements, such as an array of discrete conducting layers to define a voltage gradient to perform electrophoretic transport in a narrow fluid channel.

The ability to collect and organize atoms, molecules, nanocrystals, colloids, cells, proteins and spores on a substrate is a major goal of nanoscience, synthetic chemistry, biology and medicine, as well as national security. There has been a problem in developing a technology in which the structural scale of a template can be engineered by man to match the scale of a nanobody and thereby manipulate it to form an ordered structure or to selectively absorb the nano body enabling assay and analysis. This has been addressed using standard lithographic approaches in the past that cannot, at this time, achieve nano dimensions over significant areas in the range less than 70 nm.

Recently nanolaminate structures have been developed for sensors wherein a polished surface of the structure is exposed to a sample fluid passing thereacross. Such an approach is described and claimed U.S. application Ser. No. 10/167,926, filed Jun. 11, 2002. Also, sensors utilizing separated nanolaminate structures, each having a polished surface exposed to a sample fluid have been developed, with this approach being described and claimed in U.S. application Ser. No. 10/(IL-1090), filed ______, 2002.

As established by the above-referenced copending applications, it has been shown possible to synthesize periodic arrays of metallic and insulating layers with nanometer scale precision, and process them to create flat, exposed, striped surfaces by cutting the substrate and the deposited alternating layers perpendicular to the planes of these layers, as described hereinafter with respect to FIG. 1. Thus, the flat, exposed, striped surfaces, referred to as nanolaminate structures, may be exposed to a sample fluid for electrophoretic applications, for example.

The present invention utilizes these nano-laminate layered structures to produce electrophoretic devices wherein the nanolaminate structures are mounted perpendicular to a sample fluid flow and provided with shields to cause the sample fluid to flow past the structures in only a desired direction. For example, the nanolaminate structures may be so constructed and mounted in a device so as to use an array of discrete conducting layers to define a voltage gradient for performing electrophoretic transport in a narrow-fluid channel with one surface defined by the nanolaminate structure. The structure may be positioned and mounted such the sample fluid flows over the flat nanolaminate surface in a direction that makes an angle to the exposed, stripes at the surface formed by the exposed alternating layers of the nanostructure. It is understood that the layers may be alternating conductive and insulating layers, but the sequential conductive layers may be formed of different conductive material or of the same conductivity.

### SUMMARY OF THE INVENTION

It is an object of the present invention to provide an electrophoretic device which utilizes a nanolaminate structure.

A further object of the invention is to provide an electrophoretic device having a nanolaminate structure mounted whereby the exposed stripes are at an angle to sample fluid flow.

A further object of the invention is to provide an electrophoretic device having a nanolaminate structure mounted whereby the exposed stripes are perpendicular to sample fluid flow.

Another object of the invention is to provide an electrophoretic device which uses an array of discrete conducting layers to define a voltage gradient across the exposed stripes of the nanolaminate structure so as to perform electrophoretic transport in a narrow channel with one surface defined by the nanolaminate structure. Other objects and advantages of the invention will become apparent from the following description and accompanying drawings. Basically, the present invention involves electroporetic devices with nanometer-scale, metal elements. The metallic elements for the devices comprise nanolaminated structures having alternating layers of a conductive material and an insulating material wherein a flat, exposed, striped surface is formed on the nanolaminated structure by cutting it perpendicular to the planes of the alternating layers. This flat exposed, striped surface of the nanolaminated structure is mounted so as to form a surface of a channel through which sample fluid passes. The devices are constructed by forming flow channels along the exposed surface of the nanolaminate structure whereby the formed flow channels may be of a long-narrow, or short-wide configuration. By forming the flow channel to be perpendicular to the direction of the striped surface, an array of discrete conducting layers is able to define a voltage gradient across the nanolaminated structure so as to perform electrophoretic transport in a narrow fluid channel, with one surface of the channel defined by the nanolaminate structure. The nanolaminate structure may be provided with a power supply connected across the width or length of the nanolaminated structure to produce a required electric field for electrophoretic applications. The device of this invention, while particularly applicable for electrophoretic applications can be incorporated in a microfluidic device for the purpose of processing, separating, or performing a chemical or biological assay or analysis on a very small fluid sample. Such devices can be used as detectors of pathogens or other trace analytes.

### BRIEF DESCRIPTION OF THE DRAWINGS

The accompanying drawings which are incorporated into and form a part of the disclosure, illustrate embodiments of the invention and, together with the description, serve to explain the principle of the invention.

FIG. 1 is a perspective view of an embodiment of a nanolaminated structure.

FIGS. 2A, 2B and 2C are views of electrophoretic devices having differently configured fluid flow channels located adjacent an exposed, striped surface of microlaminated structure similar to that of FIG. 1.

FIGS. 3 and 4 illustrate voltage connection to a microlaminated structure to produce different electric fields across the exposed, striped surface of a microlaminated structure similar to the structure of FIG. 1.

### DETAILED DESCRIPTION OF THE INVENTION

The present invention involves electrophoretic devices with nanometer-scale, metallic elements. The invention involves the use of nanolaminate structures consisting of alternating layers of conducting and insulating materials. The layers can be exceedingly thin of an order of a few atomic layers and up to hundred of nanometers. The thus formed nanolaminate structures are cut perpendicular to the planes of the alternating layers, which results in an exposed surface having closely spaced alternating stripes of the conducting and insulating materials. This patterned surface may be incorporated into electrochemical and electrophorectic devices. One embodiment of such a device, as described hereinafter uses the array of discrete conducting layers to define a voltage gradient so as to perform electrophoretic transport in a narrow fluid channels, with one surface of that channel defined by the exposed, striped, surface of the nanolaminate structure.

The array of conducting and insulating layers of the nano-laminate may be of the same or different materials or even the same or different thicknesses or even of materials, whereby the voltage drop thereacross may be different for each metal layer or series of layers, etc. Also, the device of this invention may include a voltage source connected across different areas of the nanolaminate structure to produce different electric fields parallel or perpendicular to the exposed, striped surface of the nano-laminated structure.

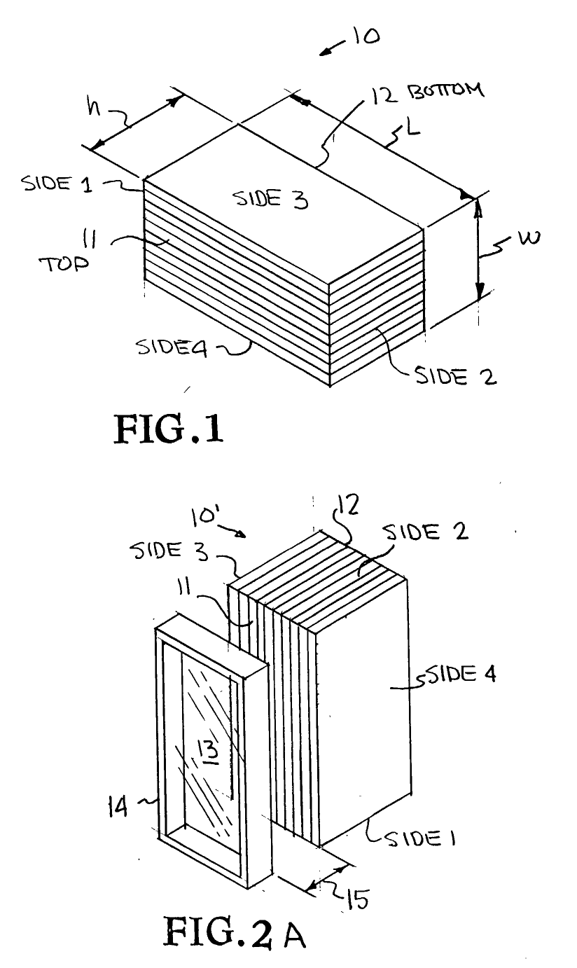

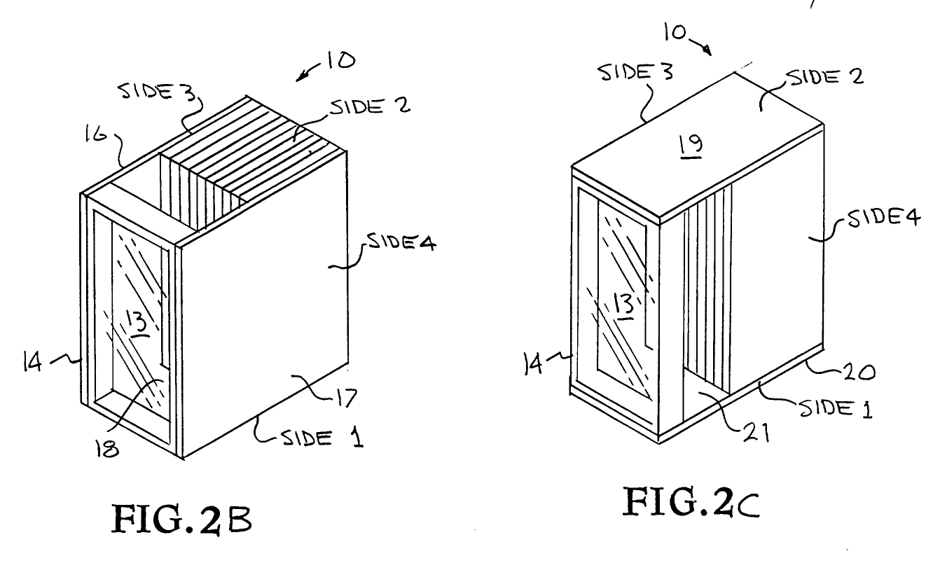

As pointed out above, it has been shown possible to synthesize periodic arrays of metallic and insulating layers with nanometer-scale precision, and process them to create flat, striped surfaces (see FIG. 1). The exposed, plan, striped surface may be used to define a width of a fluid channel of submicron to millimeter height or length, depending on the position of the striped surface (vertical or horizontal). By placing additional parallel or perpendicular surfaces at the desired distance from the striped surface of the microlaminate and sealing gaps at the sides of the microlaminates, flow channels are formed with the striped surface defining a surface or wall of the flow channel, as shown in FIGS. 2A-2C and described hereafter.

Referring now to FIG. 1, a microlaminate structure, generally indicated at 10, which has been cut to expose a striped surface 11, formed by an array alternating conducting and insulating layers. The structure 10 has a length (L), a width (W), and a height (H). For purpose of illustration, the striped surface 11 is referred to hereinafter as a top surface, and an opposite surface 12 referred to as a bottom surface, as more clearly understood relative to the embodiments of FIGS. 2A-2C, 3, and 4. The structure 10 includes sides or ends 1 and 2, and sides or surfaces 3 and 4. In the embodiment of FIG. 1, the surface (top) 11 and surface (bottom) 12 and sides 1 and 2 are cut and polished to be flat and smooth, whereby the alternating layers of structure 10 are exposed on four (4) surfaces. Generally, these surfaces are planar and Cartesian, parallel or perpendicular to the normal axis defined by the material layers, but the machining process of the nanolaminated structures need not be so-restricted. For the purpose of the embodiments of FIGS. 2A-2C, 3 and 4, it will be assumed that the composite or nanolaminated structure 10 is a bimaterial, made of equally spaced layers of insulator and metal. The number and types of materials, and the thickness of the successive layers may differ from this assumption, as determined by the deposition procedure. As pointed out above, the layer thickness and/or material composition may vary from layer to layer or section to section, whereby the conductivity of the individual or layer section may be different.

In the embodiments of FIGS. 2A-2B-2C, an enlarged version of the microlaminate structure 10 of FIG. 1 is utilized with the structure 10′ positioned with side 1 down, side 2 up, surface (top) 11 at the front, and surface (bottom) 12 at the rear. In each of the embodiments of FIGS. 2A-2C, the surface (top) 11 of structure 10′ forms one wall of a fluid flow channel. An insulating wall 13 of the channel spaced from the surface 11 may be composed of transparent material, such as glass, and is retained in a box or housing 14. As seen in FIG. 2A, the opposing surface 11 and insulating wall 13 are separated by a gap 15 that will form the fluid channel, as seen in FIGS. 2B-2C, but in FIG. 2A, the sides of the channel have not been closed.

In FIG. 2B, sides 3 and 4 of the nanolaminate structure 10′ are sealed by layers or plates 16 and 17 to housing 14 which are secured to the walls or sides 3 and 4. This forms a vertical channel 18 extending from side 1 to side 2 of structure 10′ with openings at the bottom (side 1) and top(side 2) that will be connected to two, separate fluid reservoirs, not shown.

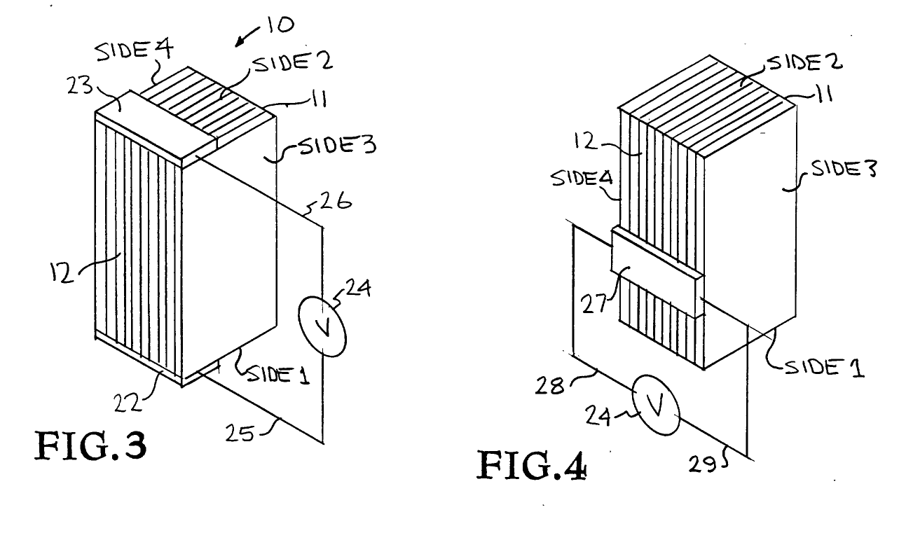

In FIG. 2C, sides 1 and 2 of the structure 10′ are sealed by layers or plates 19 and 20 to housing 14, leaving a horizontal channel 21 extending from side 3 to side 4 of structure 10′. Because of the typical deposition procedure, the nanolaminate structure 10′ is commonly of dimensions W<L, so it is assumed that the fluid channel in FIG. 2B is long and narrow, and in FIG. 2C is wide and short. The channel 18 (FIG. 2B) flows electrophoretically from bottom to top (side1 to side 2), and in channel 21 the direction is from the left to right (side 3 to side 4), which implies an electric field along the channel, as described hereinafter with respect to FIGS. 3 and 4.

FIGS. 2B and 2C may be generalized to create the side channel walls by patterning lines of the adhesive used to cement the nanolaminate and covering material together; multiple channels can thereby be constructed. The channel can be defined manually or mechanically with ordinary adhesives and can be macroscopically wide, or a film may be deposited, patterned, and etched to define microscopic channels. The channels are suitable for electrophoretic flow provided that a voltage gradient can be established along their length. This ordinarily requires that the channel be defined by entirely insulating walls. The voltage gradient is then supported by resistance to the ion conduction and electrophoretic flow through the narrow channel. It is difficult to impose a potential gradient along the channels in FIG. 2B, because the conducting stripes will tend to establish an equipotential along their length. A voltage drop is only maintained if an electrical current is flowing within the metal nanolayers; in that case, the intrinsic film resistance gives rise to a potential drop along the channels. This situation may be achieved in FIG. 2B by making good electrical contacts to the sides 1 and 2 of the nanolaminate material to define electrodes, and passing a current between them (see FIG. 3). Ohmic heating will likely be high, unless the metal layers are sufficiently thin and widely spaced and of high resistivity, and unless the total volume of the nanolaminate material is kept small (i.e., the nanolaminate must be polished so that H is small). A reasonable figure of merit would be the ratio of total electrical resistance of the metal layers in the nanolaminate wall to the resistance of the electrolyte channel, which ratio must be kept low. The layered nanolaminate design also encompasses heterostructures composed of semiconductor materials, either heavily doped and conducting, or undoped and insulating. The resistivity of the doped layers can easily be controlled during the layer deposition process so that the requisite figure of merit is achieved. Similarly, nanolaminates may be constructed with layers of non-stoichiometric insulators such as indium-tin oxide, or oxygen deficient zinc oxide, among other possible heavily doped semiconductors.

Rather than FIG. 2B, it is better to establish an electric field along the channel according to FIG. 2C. This can be done by holding successive metallic layers at a steadily increasing potential, which can be practically achieved by bonding the “bottom” of the composite to a resistive film and passing a current through that film, perpendicular to the nanolaminations (see FIG. 4). Now, the Ohmic heating will be physically separated from the fluid sample, and the film resistance can also be made high, so that the heating is small. Each successive metal layer will be kept at a slightly different potential on the top surface of the nanolaminate. The design relies upon the demonstrated electrical isolation of the adjacent metallic layers for spacings as small as hundreds of nanometers. The voltage differences that are envisioned between the adjacent layers will be fractions of a volt, far below the breakdown voltage of the nanolaminate composite.

Referring now to FIGS. 3 and 4, the nanolaminated structures 10′ are shown reversed relative to FIGS. 2B and 2C such that the surface (bottom) 12 is shown, and electrical circuits incorporating the nanolaminate metallic layers are shown for FIGS. 2B and 2C, as discussed above. The applied current induces a potential gradient across the surface (Top) 11 of the microlaminate. This electric field induces electrophorectic flow in the double layer of the fluid channel in FIGS. 2B and 2C. In FIG. 3, the electrical current passes through the nanolaminate metal layers, giving an electric field parallel to the metallic layers in FIG. 2B. This is accomplished by positioning conductive members or films 22 and 23 on sides 1 and 2 of structure 10′ which are connected to a voltage source 24 via leads 25 and 26.

In FIG. 4, the electrical current is passed perpendicular to the metal layers of the nanolaminate of FIG. 2C. This is accomplished by positioning a conductive member or film 27 across surface (bottom) 12 of structure 10′ which is connected to a voltage source 24′ via leads 28 and 29, with the conductive member 27 being in electrical contact with each metallic layer of nanolaminate 10′. Each metallic layer is held at a particular potential, which varies gradually from layer to layer. If the gradient is small, the nearby metallic layers will have very similar potentials so that electrochemistry between the layers does not occur. The applied voltage may be D.C. or time-dependent. The metallic layers should be spaced by less than several Debye lengths of the electrolyte so that the electric field is approximately uniform along the channel, but the design allows larger spacings as well.

Combinations of electrodes in FIGS. 3 and 4 will give an electric field at an angle to the metal layers.

It has thus been shown that the present invention provides electrophoretic devices which utilize nanolaminated structures and enable the use of an array of discrete conductive layers to define a voltage gradient so as to perform electrophoretic transport in a narrow fluid channel with one surface of the channel defined by the nanolaminated structure.

While particular embodiments, along with materials, etc. have been described and/or illustrated to exemplify and teach the principle of the invention, such are not intended to be limiting. Modifications and changes may become apparent to those skilled in the art, and it is intended that the invention be limited only by the scope of the appended claims.

What is claimed is:

1. In an electrophoretic device, the improvement comprising:
a nanolaminated structure, and
means for producing an electric field across conductive layers of said nanolaminated structure.

2. The improvement of claim 1, wherein said electric field is parallel to the conductive layers.

3. The improvement of claim 1, wherein said electric field is perpendicular to or at a given angle to the conductive layers.

4. The improvement of claim 1, wherein said nanolaminated structure has at least two sides wherein said conductive layers are exposed, and
additional including means operatively connected to at least one of said two sides for providing a voltage across said conductive layers.

5. The improvement of claim 4, wherein said means includes a conductive member extending across said nanolaminated structure.

6. The improvement of claim 4, wherein said means includes a pair of conductive members extending across opposite ends of said nanolaminated structure.

7. The improvement of claim 4, additionally including means for forming a fluid flow channel adjacent said conductive layers.

8. The improvement of claim 7, wherein said fluid flow channel extends parallel to said conductive layers.

9. The improvement of claim 7, wherein said fluid flow channel extends perpendicular to or at an angle to said conductive layers.

10. The improvement of claim 7, wherein said conductive layers form a wall surface of said fluid flow channel.

11. The improvement of claim 1, additionally including a fluid flow channel adjacent said conductive layers.

12. The improvement of claim 11, wherein said conductive layers define a wall surface of said fluid flow channel.

13. The improvement of claim 11, wherein said fluid flow channel extends parallel to said conductive layers.

14. The improvement of claim 11, wherein said fluid flow channel extends perpendicular to said conductive layers.

15. The improvement of claim 11, wherein said fluid flow channel includes a transparent or opaque, insulating section.

16. The improvement of claim 15, wherein said section is mounted in a housing, and said housing being connected in sealed relation to said nanolaminated structure, whereby said fluid flow channel extends in a direction parallel to or perpendicular or at any angle to said conductive layers of said nanolaminated structure.

17. A device with nanometer-scale, metallic elements, comprising:
a nanolaminated structure having at least two sections containing exposed conductive stripes,
a fluid flow channel wherein one of said two sections defines a wall surface thereof, and
a voltage supply operatively connected to at least a portion of said exposed conductive stripes for producing an electric field.

18. The device of claim 17, wherein said fluid flow channel extends in a direction relative to said exposed conductive stripes selected from the group consisting of a parallel direction and a perpendicular direction.

19. The device of claim 17, wherein said voltage supply is connected so as to produce an electric field selected from the group consisting of parallel to said exposed conductive stripes and perpendicular to said exposed conductive stripes.

20. The device of claim 17, wherein said fluid flow channel includes a transparent or insulating section.

21. The method for forming an electrophoretic device, comprising:
providing a nanolaminated structure having at least two sections with exposed conductive layers,
forming a fluid channel which includes at least a section with exposed conductive layers as a wall thereof, and
providing a current source for producing an electric field across said exposed conductive layers.

22. The method of claim 21, wherein forming the fluid channel is carried out such that fluid flow through the channel is selected from the group consisting of parallel to the exposed conductive layers and perpendicular to said conductive layers.

23. The method of claim 21, wherein providing the current source for producing an electrical field is carried out such that the electric field is selected from the group consisting of parallel to the exposed conductive layers and perpendicular to the exposed conductive layers, and intermediate angles.
